(19) United States
(12) Patent Application Publication
(10) Pub. No.: US 2009/0019433 A1
(43) Pub. Date: Jan. 15, 2009

(54) METHOD AND SYSTEM FOR DESCRIBING WHOLE-PROGRAM TYPE BASED ALIASING

(75) Inventor: Raul E. Silvera, Woodbridge (CA)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/775,266

(22) Filed: Jul. 10, 2007

(51) Int. Cl. G06F 9/45

(52) U.S. Cl. 717/156

(57) ABSTRACT

A compilation system for whole-program type based aliasing, the system includes: a set of hardware and networking resources; a front-end, a whole-program optimization component; a backend; an algorithm implemented on the set of hardware and networking resources; wherein the algorithm configures the front-end to a specific programming language being compiled and processes one source file at a time; wherein the whole-program optimization component merges the aliasing information from multiple invocations of the front-end into a single aliasing representation of a whole program; and wherein the backend uses that information to optimize and generate executable code that is the output of the compilation system.

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to computer software and programming languages, and more particularly to a method and system for whole-program type based aliasing, by applying type-based language rules across compilation emits on a whole-program compilation basis.

2. Description of the Related Art

Many programming languages, including C and C++, have language rules to restrict when pointer dereferences can overlap, and that define how data structures of different types can be aliased to each other. In this context, aliasing refers to whether the pointers may be pointing to the same or overlapping memory locations. Many compilers take advantage of these aliasing rules (also known as strict aliasing) to perform optimizations. The aliasing rules allow the compiler to assume that two memory accesses will not reference the same memory location so they can be reordered. The aliasing rules are language-specific, and are typically applied by the front-end of the compilation system to create the aliasing information to be utilized by optimization components. However, the traditional mechanism to do the aliasing is restricted to a single file or compilation unit, and is unable to provide refined aliasing across compilation units (whole program optimizers), with the front-end only processing one compilation unit at a time. A program is composed of multiple compilation units, and even if the compiler can perform whole-program optimization it normally has to make conservative assumptions regarding the potential overlap of pointers from different compilation units.

Current solutions for the problem of aliasing over multiple compilation units include describing type information on intermediate representations of a program being compiled. However, the approach of describing type information on intermediate representations of a program has several drawbacks. First, the approach moves the language-specific rules to the optimization component, which affects maintainability of the component as the language-specific rules must be duplicated on the front-end and the optimizer; second, the approach requires the optimizer component to maintain a very large aliasing relationship that is proprortional to the square of the number of symbols in the whole program. Additional approaches require the front-end component to have extended scope over the whole program, which is impractical as it prevents separate compilation of different compilation units and affects scalability of the analysis. Therefore, there is a need for a method and system that enables whole-program type based aliasing.

### SUMMARY OF THE INVENTION

Embodiments of the present invention include a method and system for whole-program type based aliasing, the method includes: creating a type aliasing graph for each compilation unit, where a nodes represents a set of objects, and an edge between two nodes indicates that the two objects may overlap; computing and assigning a unique hash value H for each data type T of each object O; creating a node N in the type aliasing graph with a value of the hash value H, if not already created, and associating the object O to the node N; computing a unique hash value H2 for each data type T2 potentially aliased to type T; creating a node N2 in the type aliasing graph with a value of the hash value H2, if not already created; creating an edge E between the nodes N and N2; wherein the creation of the type aliasing graph is carried out by a front-end in a compilation system; wherein the method further comprises: creating a whole program alias graph; creating a series of nodes M1 and M2 and edge F in the whole program alias graph that correspond to the nodes N1 and N2 and edge E of the aliasing graph of each compilation unit, where Ml has the same hash value as N1, and M2 has the same hash value as M2, and nodes from different compilation units with the same hash value are associated to the same node in the whole program alias graph; wherein the whole program alias graph is utilized to determine if each of two objects are aliased; wherein if there is no edge between each object O, the objects are not aliased; and wherein the whole program alias graph is created by whole-program optimization component in the compilation system.

A compilation system for whole-program type based aliasing, the system comprising: a set of hardware and networking resources; a front-end, a whole-program optimization component; a backend; an algorithm implemented on the set of hardware and networking resources; wherein the algorithm configures the front-end to a specific programming language being compiled and processes one source file at a time; wherein the whole-program optimization component merges the output from multiple invocations of the front-end into a single representation of a whole program; and wherein the backend generates executable code that is the output of the compilation system.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, a solution is technically achieved for whole-program type based aliasing, by applying type-based language rules across compilation units on a whole-program compilation basis.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a flow diagram that outlines a methodology for whole-program type based aliasing according to an embodiment of the invention.

FIG. 2 illustrates a system for implementing embodiments of the invention.

The detailed description explains the preferred embodiments of the invention, together with advantages and features, by way of example with reference to the drawings.

### DETAILED DESCRIPTION

Embodiments of the invention provide a method and system for whole-program type based aliasing, by applying type-based language rules across compilation units on a whole-program compilation basis. Compilation systems of embodiments of the invention are composed of three components, a front-end which is specific to the programming language being compiled (for example, C or C++) and processes one source file at a time; a whole-program optimization component, which merges the output from multiple invocations of the front-end into a single representation of a whole program; and a backend, which generates the actual executable code that is the output of the compilation systems.

In embodiments of the invention, the front-end generates a value called a hash value for each data type it encounters. The front-end must always associate the same hash value to a data type, but it may possibly use the same hash value for different data types. The front-end will encode the hash value associated to each data type as part of the aliasing representation for each compilation unit. This aliasing representation is a graph, where each node represents a data type and each edge represents a potential alias relationship between objects of that data type. The whole program optimizer reads the graphs from the output of the front-end and “stitches” them together, by merging nodes from different compilation units that have an identical hash value. The end result is an aliasing relationship for all the data types used in the program, which may be used for determining whether two objects from different compilation units are guaranteed to not overlap. Finally, some data types may be exempt from these aliasing rules. The front-end will not associate a hash value to exempt data types, and the whole-program optimizer will not perform any alias refinement to these types.

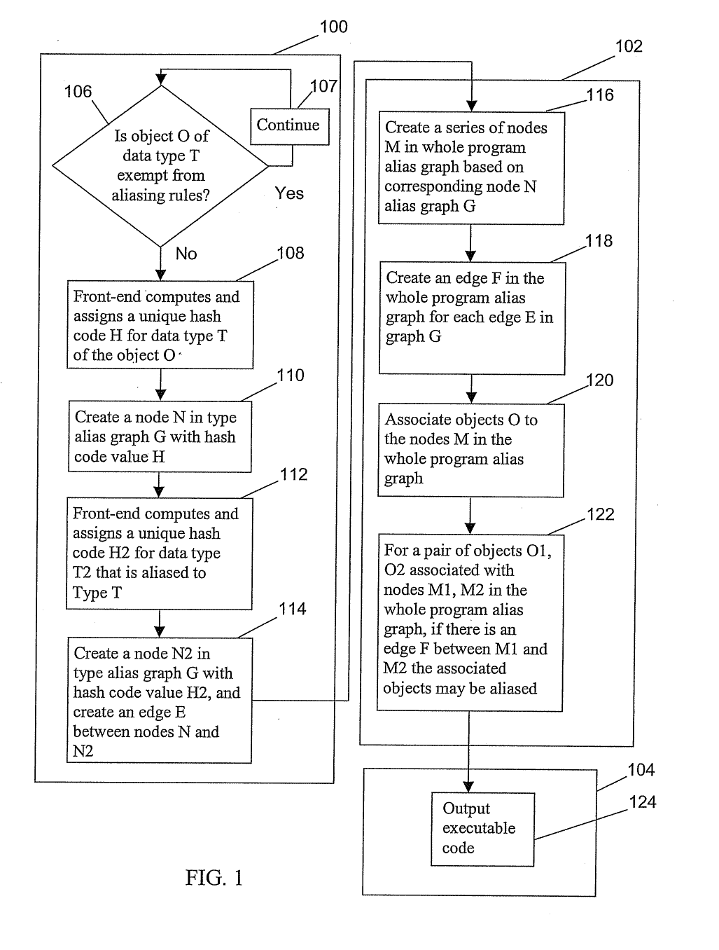

FIG. 1 is a flow diagram that outlines the methodology for whole-program type based aliasing according to an embodiment of the invention. The flow diagram is divided into the three functional areas of the compilation system including the front-end 100, the whole-program optimization component 102, and the backend 104. The front-end 100 creates a type aliasing graph for each object O of data type T in the compilation unit. If the object O of data type T is not exempt from the type-based aliasing rules (block 106 is NO) the front-end 100 computes and assigns a unique hash value H for the data type T of the object O (block 108). The front-end 100 creates a node N in the type alias graph with value of hash value H, if it doesn't exist already, and associates O to N (block 110). The front-end 100 computes a unique hash value H2 for each data type T2 that is known to be aliased to type T according to the language-specific aliasing rules (block 112). The front-end 100 creates a node N2 in the type alias graph G with a value of hash value H2, if it doesn't exist already, and creates an edge E between nodes N and N2 (block 114). For data types exempt from aliasing rules (block 106 is YES), the front-end 100 will not associate a hash value to the exempt data types, and the whole-program optimizer will not perform any alias refinement to these types. The process continues (block 107) with the next object O of data type T in the compilation unit.

The whole-program optimization component 102 creates a whole program alias graph that is used to decide if two objects are aliased. For each compilation unit in the program, with type alias graph G and each node N labeled with H in type alias graph G, the whole program optimization component 102 creates a node M in the whole program alias graph labeled with H, if it doesn't exist already (block 116). For each edge E in type alias graph G between nodes N1 and N2 with hash values H1 and H2 in type alias graph G, the whole program optimization component 102 creates an edge F in the whole program alias graph between the nodes with values H1 and H2 (block 118). For each object O in the compilation unit, if O is associated to a node N in type alias graph G with hash value H, associate O to the node M in the whole program alias graph with hash value H (block 120). For a pair of objects O1 and O2, if O1 is associated to a node M1 with hash value H1 in the whole-program alias graph, and O2 is associated to a node M2 with hash value H2 in the whole-program alias graph, and there is no edge F in the whole program alias graph between nodes M1 and M2 then O1 and O2 are not aliased; otherwise, O1 and O2 may be aliased (block 122). This information is used inside the whole-program optimization component to enable program transformations, and it is propagated to the backend to enable low-level optimizations. The backend 106 outputs executable code (block 124).

The following example code illustrates an implementation of type-based aliasing according to an embodiment of the invention.

Compilation unit 1:

```
    int a;
      double b;
struct { int a; double b;} c;
```

For compilation unit 1 the front-end will create a graph with three nodes, and two edges as follows.

nodes:

{int} −> hashcode=1, symbols=a
{double} −> hashcode=2, symbols=b
{c} −> hashcode=3, symbols=c

edges:

{c} <−> {double}
{c} <−> {int}

For a second compilation unit—compilation unit 2:

double *p;

The FE will create a graph with a single node, and no edges:

nodes:

{double}→hashcode=2, symbol=*p

The whole-program optimizer will merge the two graphs into the whole program graph:

nodes
{int} −> hashcode=1, symbols=a
{double} −> hashcode=2, symbols=b, *p
{c} −> hashcode=3, symbols=c

edges:

{c} <−> {double}
{ c } <−> {int}

From this graph, the whole-program optimizer can determine that *p and a are not aliased, because they belong to different nodes and there is no edge between those two nodes.

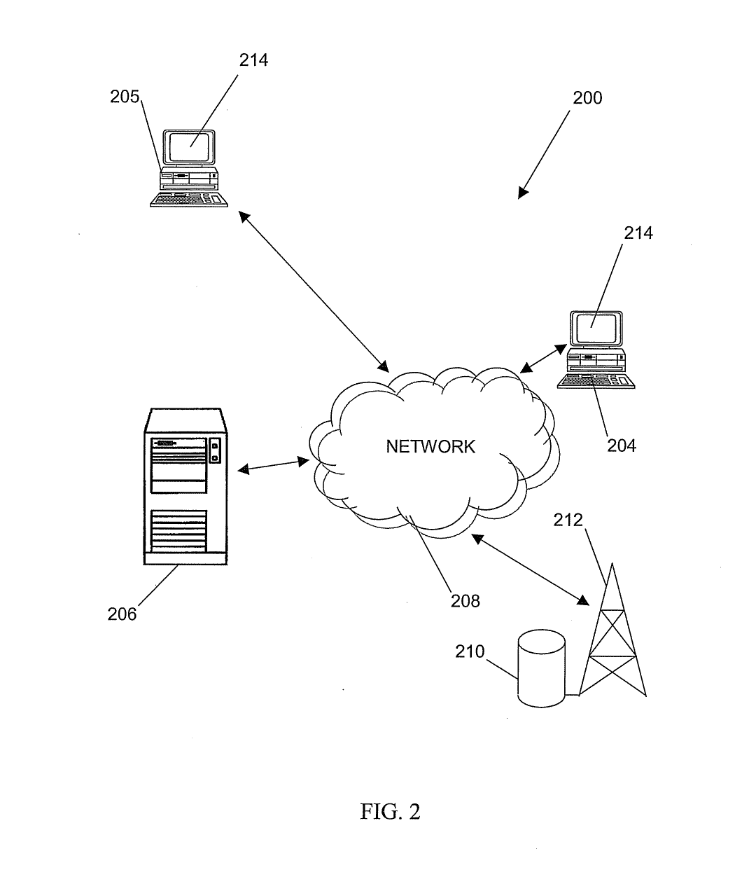

FIG. 2 is a block diagram of an exemplary system 200 for implementing an algorithm for whole-program type based aliasing. The system 200 includes remote devices including one mobile computing devices 204 and desktop computing devices 205 equipped with displays 214 for use with graphical user interface (GUI) aspects of the present invention. The remote devices 204 may be wirelessly connected to a network 208. The network 208 may be any type of known network including a local area network (LAN), wide area network (WAN), global network (e.g., Internet), intranet, etc. with data/Internet capabilities as represented by server 206. Communication aspects of the network are represented by cellular base station 210 and antenna 212. Each remote device 204 may be implemented using a general-purpose computer executing a computer program for carrying out the algorithm described herein. The computer program may be resident on a storage medium local to the remote devices 204, or maybe stored on the server system 206 or cellular base station 210. The server system 206 may belong to a public service. The remote devices 204, and desktop device 205 may be coupled to the server system 206 through multiple networks (e.g., intranet and Internet) so that not all remote devices 202, 204, and desktop device 205 are coupled to the server system 206 via the same network. The remote device 204, desktop device 205, and the server system 206 may be connected to the network 208 in a wireless fashion, and network 208 may be a wireless network. In a preferred embodiment, the network 208 is a LAN and each remote device 204 and desktop device 205 executes a user interface application (e.g., web browser) to contact the server system 206 through the network 208. Alternatively, the remote devices 204 may be implemented using a device programmed primarily for accessing network 208 such as a remote client.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for whole-program type based aliasing, the method comprising:
creating a type aliasing graph for each object (0) of a data type (T) in a compilation unit;
computing and assigning a unique hash value (H) for each data type (T) of each object (O);
creating a node (N) in the type aliasing graph with a value of the hash value H, if not already created, and associating the object (O) to the node (N);
computing an additional unique hash value (H2) for an additional data type (T2);
creating a node (N2) in the type aliasing graph with a value of the hash value (H2), if not already created;
creating an edge E between the nodes N and N2;
wherein the creation of the type aliasing graph is carried out by a front-end in a compilation system;
creating a whole program alias graph;
creating a series of nodes (M) and edge (F) in the whole program alias graph that correspond to the nodes (N1) and (N2) and edge (E) of the aliasing graph;
wherein the whole program alias graph is utilized to determine if each of two objects are aliased;
wherein if there is no edge between each object O, the objects are not aliased; and
wherein the whole program alias graph is created by whole-program optimization component in the compilation system.

2. The method of claim 1, wherein the determination of whether two objects are aliased is utilized by the whole-program optimization component to enable program transformations, and is utilized by a backend component to enable low-level optimization.

3. A method of refining aliasing during compilation of a program, the program comprising a plurality of compilation units, the method comprising:
obtaining, for each compilation unit, a local alias graph associated with an intermediate representation of that compilation unit, wherein each local alias graph comprises a plurality of nodes and a plurality of edges connecting the nodes, each node representing one data type and each edge representing a potential aliasing relationship between objects of the data types associated with the nodes connected by that edge;
for each local alias graph, annotating each node with a hash code associated with the data type represented by that node, wherein each hash code is consistent across all local alias graphs; and
generating a single global alias graph for the program by merging the local alias graphs so that each node has a hash code that is unique within the global alias graph.

4. A compilation system for whole-program type based aliasing, the system comprising:
a set of hardware and networking resources;
a front-end;
a whole-program optimization component;
a backend;
an algorithm implemented on the set of hardware and networking resources;
wherein the algorithm configures the front-end to a specific programming language being compiled and processes one source file at a time;
wherein the whole-program optimization component merges the output from multiple invocations of the front-end into a single representation of a whole program; and
wherein the backend generates executable code that is the output of the compilation system.

5. The compilation system of claim 4, wherein:
the front-end generates a hash value for each data type it encounters;
the front-end encodes the hash value associated to each data type as part of an aliasing representation for each compilation unit of the programming language being compiled;
the aliasing representation is a graph with a series of nodes each of which represent a data type, and a series of edges that represent alias relationships between objects of the data types;
the whole-program optimization component reads the graphs from separate compilation units and merges nodes with identical values to establish aliasing relationships.
